(19) United States
(12) Patent Application Publication
(10) Pub. No.: US 2010/0072435 A1
(43) Pub. Date: Mar. 25, 2010

(54) PRODUCTION METHOD OF METAL OXIDE PRECURSOR LAYER, PRODUCTION METHOD OF METAL OXIDE LAYER, AND ELECTRONIC DEVICE

(75) Inventors: Makoto HONDA, Tokyo (JP); Katsura HIRAI, Tokyo (JP)

Correspondence Address: CANTOR COLBURN, LLP, 20 Church Street, 22nd Floor, Hartford, CT, 06103, US

(73) Assignee: Konica Minolta Holdings, Inc., Tokyo (JP)

(21) Appl. No.: 12/560,676

(22) Filed: Sep. 16, 2009

(30) Foreign Application Priority Data
Sep. 20, 2008 (JP) 2008-241881

(51) Int. Cl. H01B 1/02; B05D 3/02; B05D 3/06

(52) U.S. Cl. 252/519.51; 427/314; 427/553

(57) ABSTRACT

A production method of a metal oxide precursor layer provided with a substrate, a solution containing a metal ion as a metal oxide precursor, and a process to coat the solution while the temperature of the substrate is adjusted in the temperature range of 50%-150% of the boiling point (° C.) of a main solvent of the solution.

### TECHNICAL FIELD

The present invention relates to a production method of a metal oxide precursor layer, a production method of a metal oxide layer, and an electronic device.

### BACKGROUND

It is known that amorphous oxide semiconductors can be used for thin film transistors.

As methods to form amorphous oxide semiconductors, disclosed are formation methods via a process to oxidize a metal salt or an organic metal compound (a semiconductor precursor) (for example, refer to Patent Documents 1 and 2).

In Patent Documents described above, to oxidize an oxide semiconductor precursor, thermal oxidation or plasma oxidation is employed. However, when a thermal oxidation method is used to oxidize a semiconductor precursor, it is commonly difficult to achieve desired performance in cases where no long-time oxidation is carried out at a very high temperature of a minimum of at least 300° C., practically 500° C. or higher.

Therefore, thermal oxidation exhibits poor energy efficiency and long treatment duration is required for such oxidation, resulting in difficulty in applications to resin substrates being lightweight with flexibility.

Further, in plasma oxidation, treatment is carried out in an extremely reactive plasma space, whereby a production process of a thin film transistor produces the problems that an electrode or an insulation film is deteriorated and mobility or off current (dark current) is degraded.

It is also known that an organic metal compound or a metal halide is used as a precursor to form an amorphous oxide semiconductor via thermal oxidation (for example, refer to Non-Patent Documents 1, 2, and 3).

For example, when a metal alkoxide is used as a precursor, high temperature treatment is required and then carbon remains, resulting in degraded performance. Further, when a metal halide is used as a precursor, the problem of halogen discharge is noted. Still further, these precursors exhibit decomposition properties to water and therefore are frequently allowed to be dissolved in an organic solvent which is undesirable also in view of the production environment.

[Paten Document 1] Japanese Patent Publication Open to Public Inspection (hereinafter referred to as JP-A) No. 2003-179242

[Paten Document 2] JP-A No. 2005-223231 [Non-Patent Document 1] Kagaku Kogyo, December 2006, “Zoru-geruho Niyoru Sankabutu-handotai-hakumaku No Gosei To Oyo” (Chemical Industry, December 2006, “Synthesis and Applications of Oxide Semiconductor Thin Films by Sol-gel Methods”)

[Non-Patent Document 2] Electrochemical and Solid-State Letters, 10(5), H135-H138

[Non-Patent Document 3] Advanced Materials, 2007, 19, 183-187

### DISCLOSURE OF THE INVENTION

### Problems to be Solved by the Invention

An object of the present invention is to provide a production method of a metal oxide precursor layer exhibiting excellent film forming properties (referred to also as film producing properties), a production method of a metal oxide layer using the above-produced metal oxide precursor layer, and an electronic device exhibiting enhanced mobility, a high On/Off ratio, and a low threshold voltage using the production method of a metal oxide layer.

### Means to Solve the Problems

The above object of the present invention was achieved by the following method.

In a production method of a metal oxide precursor layer, a production method of a metal oxide precursor layer provided with a substrate, a solution containing a metal ion as a metal oxide precursor, and a process to coat the solution while the temperature of the substrate is adjusted in the temperature range of 50%-150% of the boiling point (° C.) of a main solvent of the solution.

### EFFECTS OF THE INVENTION

According to the present invention, there were able to be provided a production method of a metal oxide precursor layer exhibiting excellent film forming properties (referred to also as film producing properties), a production method of a metal oxide layer using the above-produced metal oxide precursor layer, and an electronic device exhibiting enhanced mobility, a high On/Off ratio, and a low threshold voltage using the production method of a metal oxide layer.

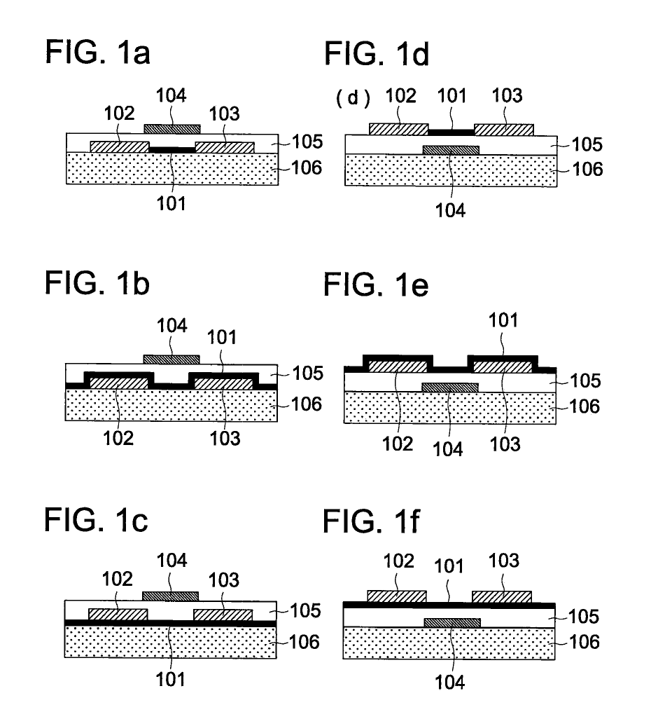

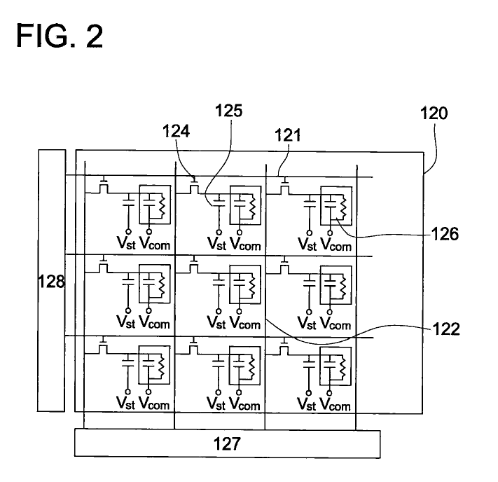

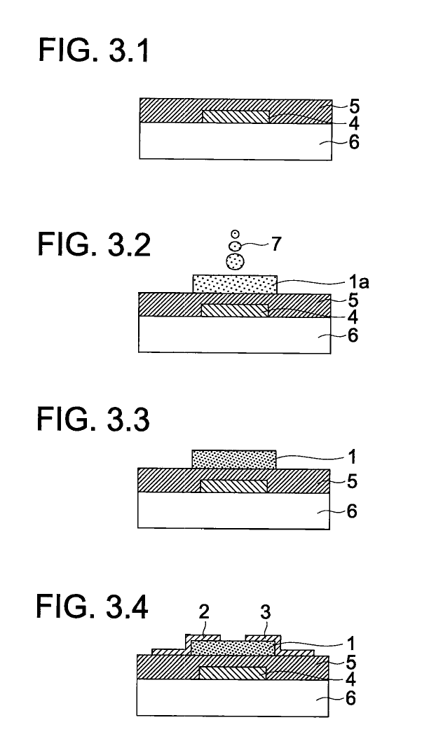

### BRIEF DESCRIPTION OF THE DRAWINGS

[FIG. 1a, FIG. 1b, FIG. 1c, FIG. 1d, FIG. 1e, and FIG. 1f] Schematic cross-sectional views showing one example of a typical element constitution of the thin film transistor of the present invention.

[FIG. 2] A schematic equivalent circuit view showing one example of a thin film transistor sheet where a plurality of the thin film transistors of the present invention are arranged.

[FIG. 3.1, FIG. 3.2, FIG. 3.3, and FIG. 3.4] Schematic cross-sectional views showing the production method of a thin film transistor of the present invention.

### DESCRIPTION OF THE SYMBOLS

1 and 101: semiconductor layers
1a: semiconductor precursor layer
2 and 102: source electrodes
3 and 103: drain electrodes
4 and 104: gate electrodes
5 and 105: gate insulation layers
7: ink-jet droplets
120: thin film transistor sheet
121: gate busline
122: source busline
124: thin film transistor
125: accumulation capacitor
126: output element
127: vertical drive circuit
128: horizontal drive circuit

### DESCRIPTION OF THE PREFERRED EMBODIMENT

When the production method of a metal oxide precursor layer of the present invention was provided with the constitution defined in claim 1, there were able to be provided a production method of a metal oxide precursor layer exhibiting excellent film forming properties (referred to also as film producing properties), a production method of a Metal oxide layer using the production method of a metal oxide precursor layer, and an electronic device exhibiting enhanced mobility, a high On/Off ratio, and a low threshold voltage using the production method of a metal oxide layer.

The preferred embodiment to carry out the present invention will now be described that by no means limits the scope of the present invention.

<<Production Method of a Metal Oxide Precursor Layer>>

The production method of a metal oxide precursor layer of the present invention will now be described.

The present inventors conducted various investigations on the above problems and thereby was able to obtain a metal oxide precursor layer exhibiting excellent film forming properties (referred to also as film producing properties) via a production method of a metal oxide precursor layer provided with a substrate, a solution containing a metal ion as a metal oxide precursor, and a process to coat the solution while the temperature of the substrate is adjusted in the temperature range of 50%-150% of the boiling point (° C.) of a main solvent of the solution, as set forth in Claim 1.

By adjusting the temperature of a substrate in the above range during coating, a fine pattern can be formed with excellent film forming properties (film producing properties) maintained, whereby an electronic device (e.g., a thin film transistor) exhibiting excellent transistor characteristics can be obtained.

Further, a coated film of a solution containing a metal ion (referred to also as a metal salt) was formed on a substrate and thereafter a process to heat and dry the film at a temperature (° C.) of at least 150% of the boiling point of a main solvent was provided, whereby a metal oxide precursor layer exhibiting further excellent film forming properties was able to be obtained.

Temperature during heating and drying is preferably set as described above from the viewpoint of preventing deformation and performance degradation during film formation of a metal oxide layer (e.g., a semiconductor active layer and a conductive layer) obtained via firing treatment to be described later (which is probably assumed to be effective to prevent an adverse effect caused by residual solvents).

Further, from the viewpoint of employing a resin substrate, a solvent featuring a boiling point allowing substrate temperature to be a process temperature of at most the heatproof temperature of a base material is preferably selected as a main solvent.

For example, when polyethersulfone, which is a heat resistant resin film, is used as a resin substrate, film forming temperature is preferably set at 250° C. or lower, more preferably at 200° C. or lower. Accordingly, when a main solvent of a solution for film formation of a metal oxide precursor layer is selected from the solvents having a boiling point of at most 167° C., preferably at most 134° C., film formation can be carried out in the temperature range, described in the present invention, during coated film formation and with respect to thermal treatment temperature after the coated film formation. Herein, when film formation is carried out at a thermal treatment temperature after coated film formation of at most 150% of the boiling point of a main solvent, a solvent having a higher boiling point can also be used in the range of the present invention.

In the present invention, to form a metal oxide precursor layer, a solution prepared by dissolving a metal salt selected from a nitrate, a sulfate, a phosphate, a carbonate, an acetate, and an oxalate in an appropriate solvent is preferably coated on a substrate in a continuous manner, and thereby productivity can remarkably be increased.

Metals in such a metal salt include Li, Be, B, Na, Mg, Al, Si, K, Ca, Sc, Ti, V, Cr, Mn, Fe, Co, Ni, Cu, Zn, Ga, Ge, Rb, Sr, Y, Zr, Nb, Mo, Cd, In, Ir, Sn, Sb, Cs, Ba, La, Hf, Ta, W, Tl, Pb, Bi, Ce, Pr, Nd, Pm, Eu, Gd, Tb, Dy, Ho, Er, Tm, Yb, and Lu.

Of the above metals, any one of indium (In), tin (Sn), and zinc (Zn) is preferably contained and in addition, gallium (Ga) or aluminum (Al) is preferably contained.

When a metal oxide semiconductor precursor solution containing these metals as components is produced, as a preferable metal composition ratio, mol fraction (metal A:metal B:metal C) of a metal (metal A) contained in a salt selected from the metal salts of In and Sn, a metal (metal B) contained in a salt selected from the metal salts of Ga and Al, and a metal (metal C═Zn) contained in a metal salt of Zn preferably satisfies the following relational expression:

Metal A:metal B:metal C=1:0.2-1.5:0-5

As metal salts, nitrates are most preferable. Therefore, using a coating liquid prepared by dissolving a nitrate of each metal in a solvent containing water or alcohol as a main component so that the mol fraction (A:B:C) of In or Sn (metal A), Ga or Al (metal B), and Zn (metal C) satisfies the above relational expression, a precursor thin layer containing such metal inorganic salts is preferably formed via coating.

(Solvents of a Metal Ion-Containing Solution)

Solvents of a metal ion-containing solution include, other than water, those dissolving a used metal salt or metal compound with no specific limitation. There can be used water; alcohols such as ethanol, propanol, or ethylene glycol; ester based solvents such as tetrahydrofuran or dioxane; ester based solvents such as methyl acetate or ethyl acetate; ketone based solvents such as acetone, methyl ethyl ketone, or cyclohexanone; glycol ether based solvents such as diethylene glycol monomethyl ether; nitrile based solvents such as acetonitrile; aromatic solvents such as xylene or toluene; hexane; cyclohexane; tridecane; α-terpineol; alkyl halide based solvents such as chloroform or 1,2-dichloroethane; N-methylpyrrolidone; and carbon disulfide.

Of these, water, alcohol such as ethanol or propanol, acetonitrile, or a mixture thereof having a boiling point of at most 100° C. is more preferably used, whereby drying temperature can be decreased and then coating on a resin substrate can be realized. Especially, a solvent containing water at 50% by mass or more or alcohol at 50% by mass or more is preferably used.

Herein, a solvent according to the present invention may be a single solvent or a mixed solvent. In the case of the mixed solvent, a main solvent refers to a solvent having the largest percent by volume based on 100% of the total of the solvents and the boiling point of the main solvent refers to the boiling point of the above solvent. Further, when percents by volume in a mixed solvent are the same (for example, in the case of 50% by volume of solvent A and 50% by volume of solvent B), the boiling points of solvent A and solvent B are compared and then the value of a higher boiling point (° C.) is employed as the boiling point of the main solvent. To heat a substrate, any appropriate temperature may be determined, provided that the temperature falls within the range of 50%-150% of the boiling point of a main solvent. However, when a substrate such as a resin substrate exhibiting relatively low heat resistance is used, there is preferably selected a solvent having a boiling point allowing the temperature range of the present invention not to exceed the heatproof temperature of the substrate.

Further, metal salts such as the above nitrates exhibit no decomposition properties to water and then can employ water as a solvent, therefore, being preferably used also in view of the production process and environment.

For example, metal salts such as a metal chloride tend to be deteriorated and decomposed (specifically gallium) and exhibit severe deliquescence properties in air. However, inorganic salts such as a nitrate according to the present invention do not deliquesce or decompose and also such salts are easy-to-use ones which are preferable in view of the production environment.

Of metal salts according to the present invention, most preferable is a nitrate exhibiting excellent properties in deterioration and decomposition with respect to water and ease of dissolution, as well as in performance such as deliquescence properties.

In the present invention, in cases in which a solution containing a metal ion is coated, a metal oxide precursor layer is formed via coating while the temperature of a substrate is adjusted at a temperature of 50%-150% of the boiling point (° C.) of a main solvent of the solvent.

Formation methods of a metal oxide precursor layer by coating a metal ion-containing solution on a substrate include a spray coating method, a spin coating method, a blade coating method, a dip coating method, a cast coating method, a roll coating method, a bar coating method, a die coating method, and a mist coating method, as well as coating methods in a broad sense including printing methods such as letterpress printing, intaglio printing, planographic printing, screen printing, or ink-jet printing. Further, methods for patterning using any of these methods are listed. Patterning may be carried out from a coated film via a photolithographic method or laser ablation.

Of these, preferable are an ink-jet method and a spray coating method enabling to carry out patterning by a liquid droplet ejection system and coating of a thin film, and the ink-jet method is most preferable.

For example, when a metal oxide precursor layer is formed using an ink-jet method, the metal oxide precursor layer is formed by dripping a metal ion-containing solution while the temperature of a substrate is adjusted at a temperature of 50%-150% of the boiling point (° C.) of a main solvent of the above solution. Herein, when a metal oxide precursor layer is formed, a formation apparatus of the metal oxide precursor layer, if provided with a temperature adjustment member, is cited as a preferred embodiment, since two processes of coating and drying are continuously performed.

(Film Thickness of a Metal Oxide Precursor Thin Layer)

It is preferable to adjust the film thickness of a metal oxide precursor thin layer according to the present invention at 1 nm-200 nm, preferably 5 nm-100 nm.

<<Production Method of a Metal Oxide Layer>>

The production method of a metal oxide layer of the present invention will now be described.

A metal oxide layer according to the present invention can be obtained by oxidizing a metal ion (referred to also as a metal salt) contained in a metal oxide precursor thin layer according to the present invention.

The metal oxide layer of the present invention is preferably a semiconductor active layer containing a metal oxide semiconductor obtained by oxidizing at least one of the metal salts selected from a nitrate, a sulfate, a phosphate, a carbonate, an acetate, and an oxalate; or a conductive layer containing a metal oxide (a conductive material) obtained via oxidation treatment.

(Semiconductor Active Layer)

A semiconductor active layer according to the present invention will now be described.

The semiconductor active layer according to the present invention is obtained in such a manner that by use of a solution containing a metal salt of a precursor of a metal oxide semiconductor, preferably a metal salt selected from a nitrate, a sulfate, a phosphate, a carbonate, an acetate, and an oxalate, a metal oxide precursor layer is formed and then the layer is oxidized.

(Metal Oxide Semiconductor)

A metal oxide semiconductor according to the present invention can be used in any of a single-crystalline state, a polycrystalline state, and an amorphous state. However, of these, an amorphous oxide is preferably used.

The electron carrier concentration of an amorphous oxide, being a metal oxide according to the present invention, formed from a metal compound material to become a precursor of a metal oxide semiconductor is only required to be less than 10¹⁸/cm³.

Electron carrier concentration is a value determined at room temperature. Room temperature is, for example, 25° C. and specifically a given temperature appropriately selected from the range of about 0° C.-40° C.

Herein, the electron carrier concentration of an amorphous oxide according to the present invention need not to be less than 10¹⁸/cm³ in the entire range of 0° C.-40° C.

For example, such electron carrier concentration is only required to be less than 10¹⁸/m³ at 25° C. When the electron carrier concentration is allowed to be further decreased to at most 10¹⁷/cm³, preferably at most 10¹⁶/cm³, a normally-off type TFT can be obtained in higher yield.

Electron carrier concentration can be determined via hall effect measurement.

The film thickness of a semiconductor active layer containing a metal oxide semiconductor is commonly at most 1 μm, specifically preferably 10 nm-300 nm, while characteristics of a transistor obtained largely varies with the film thickness of a semiconductor layer and the film thickness depends on the semiconductor.

Further, in the present invention, by controlling a precursor material (a metal salt), composition ratio, and production conditions, electron carrier concentration is preferably allowed to be, for example, 10¹²/cm³-less than 10¹⁸/cm³, more preferably 10¹³/cm³-10¹⁷/cm³, specifically preferably 10¹⁵/cm³-10¹⁶/cm³.

(Oxidation of a Metal Ion in a Metal Oxide Precursor Layer)

The production method of a metal oxide layer of the present invention will now be described.

As methods to convert a metal oxide precursor layer formed from the above metal inorganic salt to a semiconductor active layer (a metal oxide semiconductor layer) or a conductive layer via oxidation, an oxygen plasma method, a thermal oxidation method, and a UV ozone method are cited. Further, microwave irradiation to be described later can be employed.

In thermal oxidation, thermal treatment is preferably carried out in the presence of oxygen in the temperature range of 100° C.-400° C.

When a metal salt selected from a nitrate, a sulfate, a phosphate, a carbonate, an acetate, and an oxalate according to the present invention is used, oxidation treatment can be conducted at relatively low temperature.

Further, formation of a metal oxide can be detected by XPS (X-ray photoelectron spectroscopy; referred to also as ESCA) and conditions for adequate conversion to a metal oxide semiconductor or a conductive material can be selected in advance.

As an oxygen plasma method, an atmospheric pressure plasma method is preferably used. And in an oxygen plasma method and a UV plasma method, a substrate is preferably heated in the range of 50° C.-300° C.

In the atmospheric pressure plasma method, under atmospheric pressure, an inert gas such as argon gas, serving as a discharge gas, and a reactive gas (an oxygen-containing gas) are introduced into a discharge space together and then a high frequency electric field is applied for excitation of the discharge gas and for generation of plasma, which is then brought into contact with the reactive gas to generate plasma containing oxygen. Via exposure of the substrate surface thereto, oxygen plasma treatment is carried out. The term “under atmospheric pressure” represents a pressure of 20 kPa-110 kPa, preferably 93 kPa-104 kPa.

Using such an atmospheric pressure plasma method, oxygen plasma is generated by use of a gas containing oxygen as a reactive gas. A precursor thin film containing a metal salt is then exposed to the plasma space, whereby the precursor thin film is oxidized and decomposed via plasma oxidation to form a layer composed of a metal oxide.

A high frequency power supply is in the frequency range of 0.5 kHz-2.45 GHz and electric power supplied between opposed electrodes is preferably 0.1 W/cm²-50 W/cm².

A gas used is basically a mixed gas of a discharge gas (inert gas) and a reactive gas (an oxidizing gas). The reactive gas is preferably oxygen gas which is allowed to be contained preferably at 0.01-10% by volume based on the mixed gas. This ratio is more preferably 0.1% by volume-10% by volume, still more preferably 0.1% by volume-5% by volume.

The above inert gas includes the elements of the 18th group of the periodic table of the elements, specifically helium, neon, argon, krypton, and radon; and nitrogen gas. Of these, helium, argon, and nitrogen gas are preferable to produce the effects described in the present invention.

Further, a reactive gas may be introduced between electrodes, being the discharge space, at ordinary temperatures and pressures.

The atmospheric pressure plasma method is described in JP-A Nos. 11-61406, 11-133205, 2000-121804, 2000-147209, and 2000-185362.

Further, a UV ozone method refers to a method wherein ultraviolet radiation is irradiated in the presence of oxygen to advance oxidation reaction. The wavelength of such ultraviolet radiation is 100 nm-450 nm, specifically preferably about 150 nm-300 nm and so-called vacuum ultraviolet radiation is preferably irradiated.

As a light source, a low-pressure mercury lamp, a deuterium lamp, a xenon excimer lamp, a metal halide lamp, or an excimer laser can be used.

The output power of such a lamp is 400 W-30 kW and the illuminance thereof is 100 mW/cm²-100 kW/cm². The irradiation energy thereof is preferably 10 mJ/cm²-5000 mJ/cm², more preferably 100 mJ/cm²-2000 mJ/cm².

Illuminance during ultraviolet irradiation is preferably 1 mW-10 W/cm².

Further, in the present invention, in addition to oxidation treatment, thermal treatment is preferably carried out after the oxidation treatment or at the same time as the oxidation treatment. Thereby, the oxidation treatment can be accelerated.

Specifically, it is preferable that after oxidation treatment of a metal oxide precursor layer according to the present invention, a substrate be heated at 50° C.-200° C., preferably at 80° C.-150° C. in the range of 1 minute-10 hours as heating duration.

Thermal treatment and oxidation treatment may be carried out at the same time. Thereby, conversion to a metal oxide semiconductor or a conductive material via oxidation can rapidly be performed.

The film thickness of an active semiconductor layer or a conductive layer containing a metal oxide semiconductor formed via oxidation treatment of a metal ion is preferably 1 nm—200 nm, more preferably 5 nm-100 nm.

(Microwave Heating)

In the present invention, as a method to convert a layer formed from a solution containing an organic metal ion, becoming a precursor of a metal oxide semiconductor, to a semiconductor, microwave irradiation is preferably employed in the presence of oxygen. Such microwave irradiation can be used alone or in combination of any of various other heating members.

Namely, a layer containing a precursor of such a metal oxide semiconductor is formed and thereafter electromagnetic radiation, specifically microwave (frequency: 0.3 GHz-50 GHz) is irradiated to the thin film.

Via microwave irradiation to a layer containing a precursor of a metal oxide semiconductor, electrons in the metal oxide semiconductor precursor are vibrated, followed by generation of heat, and then the layer is uniformly heated from the inside. A substrate such as glass or a resin exhibits almost no absorption properties in the microwave range. Therefore, the substrate itself generates almost no heat and only the thin film portion is selectively subjected to thermal oxidation by heating to carry out conversion to an oxide semiconductor.

As generally shown in microwave heating, microwave absorption is concentrated on a substance exhibiting large absorption properties and temperature elevation can be performed in a very short period of time. Thereby, when this method is employed for the present invention, a substrate itself is almost unaffected by heating via electromagnetic radiation and temperature elevation can be performed, in a short period of time, up to a temperature where only a precursor layer is subjected to oxidation reaction. Then, an oxide precursor can be converted to a metal oxide. Further, heating temperature and heating duration can be controlled by the output power and irradiation duration of microwave, being adjustable based on the types of a precursor material and a substrate material.

Generally, microwave refers to electromagnetic radiation having a frequency of 0.3 GHz-50 GHz. All the followings are electromagnetic radiation categorized into microwave: 0.8 GHz-1.5 GHz band and 2 GHz band used in mobile communication; 1.2 GHz band used in amateur radio and airplane radar; 2.4 GHz band used in microwave ovens, internal radio, and VICS; and 3 GHz band used in vessel radar, as well as 5.6 GHz used in ETC communication. Further, transmitters featuring 28 GHz or 50 GHz are available on the market.

A further excellent oxide semiconductor layer can be obtained using a heating method via electromagnetic radiation (microwave) irradiation, compared to a common heating method using an oven. When an oxide semiconductor is produced from an oxide semiconductor precursor material, produced is an effect suggesting action other than conductive heat, for example, direct action of electromagnetic radiation on the oxide semiconductor precursor material. This mechanism incompletely becomes clear. However, it is presumed that conversion of an oxide semiconductor precursor material to an oxide semiconductor via hydrolysis, dehydration, decomposition, or oxidation was accelerated by electromagnetic radiation.

A method to carry out semiconductor conversion treatment via microwave irradiation to a semiconductor precursor layer containing the above precursor is one to selectively advance oxidation reaction in a short period of time. Herein, microwave irradiation in the presence of oxygen is preferable in view of advancing oxidation reaction of an oxide semiconductor precursor in a short period of time. However, heat is transferred to a substrate via heat conduction to no small extent. Therefore, especially in the case of a substrate such as a resin substrate exhibiting relatively low heat resistance, treatment is preferably carried out so that the surface temperature of a thin film containing a precursor is 100° C.-less than 400° C. by controlling the output power, irradiation duration, and the number of times of irradiation of microwave. The temperature of the thin film surface and the temperature of the substrate can be determined using a surface thermometer employing a thermocouple or a non-contact surface thermometer.

Further, when a strong electromagnetic absorption body such as ITO exists in the vicinity (for example, a gate electrode), this also generates heat by absorbing microwave, whereby an area in the vicinity thereof can further be heated in a short period of time.

An oxide semiconductor thin film formed from a precursor can be used for various types of semiconductor elements or electronic circuits such as transistors or diodes. A solution of a precursor material is coated on a substrate, whereby an oxide semiconductor material layer can be produced in a low temperature process and therefore, applications to production of semiconductor elements such as thin film transistors (TFT elements) employing a resin substrate can preferably be made.

An oxide semiconductor is applicable to diodes or photosensors. For example, lamination with a metal thin film composed of an electronic material to be described later also makes it possible to produce Schottky diodes or photodiodes.

In the present invention, there can be provided electronic devices exhibiting excellent characteristics via production employing a production method of a metal oxide layer according to the present invention. Herein, of such electronic devices, a thin film transistor, specifically preferably used, will now be described as an example.

(Element Constitution)

FIG. 1 is a view showing a typical element constitution of a thin film transistor employing a metal oxide semiconductor according to the present invention.

Several constitutional examples of the thin film transistor are shown in FIGS. 1a-1f as cross-sectional views. In FIG. 1, source electrode 102 and drain electrode 103 are constituted so that semiconductor layer 101 composed of a metal oxide semiconductor is connected as a channel.

In FIG. 1a, source electrode 102 and drain electrode 103 are formed on support 106 by the method of the present invention. The resulting product is allowed to serve as a base material (a substrate) and then semiconductor layer 101 is formed between both electrodes. Gate insulation layer 105 is formed thereon and further thereon, gate electrode 104 is formed to form an electric field effect thin film transistor. In FIG. 1b shows a manner in which semiconductor layer 101, which is formed between the electrodes in FIG. 1a, is formed by a coating method so as to entirely cover the electrodes and the support surface. In FIG. 1c, semiconductor layer 101 is initially formed on support 106, followed by formation of source electrode 102, drain electrode 103, insulation layer 105, and thereafter gate electrode 104 is formed. In the present invention, it is only necessary to form a semiconductor layer via the method of the present invention.

In FIG. 1d, gate electrode 104 is formed on support 106, followed by formation of gate insulation layer 105, and thereon, source electrode 102 and drain electrode 103 are formed to form semiconductor layer 101 between the electrodes. In addition, the constitutions as shown in FIGS. 1e and 1f are also employable.

FIG. 2 is a schematic equivalent circuit view showing one example of a thin film transistor sheet wherein a plurality of thin film transistors are arranged.

Thin film transistor sheet 120 incorporates a large number of thin film transistors 124 matrix-arranged. The symbol 121 represents a gate busline for the gate electrode of each thin film transistor 124, and the symbol 122 represents a source busline for the source electrode of each thin film transistor 124. The drain electrode of each thin film transistor 124 is connected with output element 126, being, for example, a liquid crystal or an electrophoretic element which constitutes a pixel of a display device. In the illustrated example, a liquid crystal serving as output element 126 is shown by an equivalent circuit composed of a resistor and a capacitor. The symbols 125, 127, and 128 represent an accumulation capacitor, a vertical drive circuit, and a horizontal drive circuit, respectively.

The present invention can be employed in production of the source and drain electrodes, the gate electrode, and the gate busline and the source busline of each transistor element, as well as circuit wiring in such thin film transistor sheets 120.

Next, each of the components constituting a TFT element will now be described.

(Electrodes)

In the present invention, conductive materials used for electrodes such as a source electrode, a drain electrode, a gate electrode constituting a TFT element are only required to be conductive at the practically viable level as an electrode, being not specifically limited. There are used platinum, gold, silver, nickel, chromium, copper, iron, tin, antimony lead, tantalum, indium, palladium, tellurium, rhenium, iridium, aluminum, ruthenium, germanium, molybdenum, tungsten, tin.antimony oxide, indium.tin oxide (ITO), fluorine-doped zinc oxide, zinc, carbon, graphite, glassy carbon, silver paste and carbon paste, lithium, beryllium, sodium, magnesium, potassium, calcium, scandium, titanium, manganese, zirconium, gallium, niobium, sodium, sodium/potassium alloy, magnesium, lithium, aluminum, magnesium/copper mixtures, magnesium/silver mixtures, magnesium/aluminum mixtures, magnesium/indium mixtures, aluminum/aluminum oxide mixtures, and lithium/aluminum mixtures.

Conductive polymers and metal fine particles can also preferably be used as conductive materials. As dispersed materials containing metal fine particles, for example, well-known conductive pastes may be used. However, preferable are dispersed materials containing metal fine particles of a particle diameter of 1 nm-50 nm, preferably 1 nm-10 nm. To form an electrode from metal fine particles, the above method can be used in the same manner and any of the above metals can be used as materials for such metal fine particles.

(Formation Method of Electrodes)

Formation methods of an electrode include a method in which a conductive thin film, formed by a method such as deposition or sputtering using the above material as a raw material, is formed into an electrode via a photolithographic method or a lift-off method known in the art; and a method in which a resist is formed on a metal foil such as aluminum or copper via heat transfer or ink-jet printing, followed by being etched. Further, patterning may directly be carried out via an ink-jet method using a conductive polymer solution or dispersion, or a dispersion containing metal fine particles, or pattern formation may also be conducted from a coated film via lithography or laser ablation. Still further, employable is a method in which a conductive ink or a conductive paste containing a conductive polymer or metal fine particles is subjected to patterning via a printing method such as letterpress, intaglio, planographic, or screen printing.

As a method to form an electrode such as a source, drain, or gate electrode and a gate or source busline without patterning of a metal thin film using a photosensitive resin via etching or lift-off, a method employing an electroless plating method is known.

With regard to a formation method of an electrode via a electroless plating method, as described in JP-A No. 2004-158805, a portion to be provided with an electrode is patterned, for example, via a printing method (including ink-jet printing) using a liquid containing a plating catalyst acting with a plating agent to induce electroless plating, followed by allowing the plating agent to be brought into contact with the portion to be provided with an electrode. Thereby, via contact of the catalyst and the plating agent together, the above portion is subjected to electroless plating to form an electrode pattern.

The application of such an electroless plating catalyst and a plating agent may be reversed. Further, preferable is a method to form a plating catalyst pattern and then to apply a plating agent thereto.

As printing methods, for example, screen printing, planographic printing, letterpress printing, intaglio printing, or printing employing an ink-jet method is used.

(Gate Insulation Film)

As a gate insulation film of the thin film transistor of the present invention, various types of insulation films can be used. However, an inorganic oxide coated film exhibiting high dielectric constant is specifically preferable. Examples of such an inorganic oxide include silicon oxide, aluminum oxide, tantalum oxide, titanium oxide, tin oxide, vanadium oxide, barium strontium titanate, barium zirconate titanate, lead zirconate titanate, lead lanthanum titanate, strontium titanate, barium titanate, barium magnesium fluoride, bismuth titanate, strontium bismuth titanate, strontium bismuth tantalate, bismuth tantalate niobate, and yttrium trioxide. Of these, silicon oxide, aluminum oxide, tantalum oxide, and titanium oxide are preferable. An inorganic nitride such as silicon nitride or aluminum nitride can also preferably be used.

Formation methods of the above coated film include a dry process such as a vacuum deposition method, a molecular beam epitaxy method, an ion cluster beam method, a low energy ion beam method, an ion plating method, a CVD method, a sputtering method, or an atmospheric pressure plasma method; and a wet process including a coating method such as a spray coating method, a spin coating method, a blade coating method, a dip coating method, a casting method, a roll coating method, a bar coating method, or a die coating method and a patterning method such as common printing or ink-jet printing. Any of these methods can be used, based on the kind of a material used.

As such a wet process, there is used a method in which a liquid prepared by dispersing inorganic oxide fine particles in any appropriate organic solvent or water using a dispersion aid such as a surfactant is coated and dried; and a so-called sol-gel method in which a solution of an oxide precursor, for example, an alkoxide compound is coated and dried.

Of all of these, the above-mentioned atmospheric pressure plasma method is preferable.

A gate insulation film (layer) is also preferably constituted of an anodized film or the anodized film and an insulation film. Such an anodized film is desirably subjected to sealing treatment. The anodized film is formed via anodization of an anodizable metal using a well-known method.

The anodizable metal includes aluminum and tantalum. The anodization method is not specifically limited and any well-known method is employable.

Further, as an organic compound coated film, there may be used polyimide, polyamide, polyester, polyacrylate, and photoradical polymerization-based or photo-cationic polymerization-based photocurable resins, as well as copolymers containing acrylonitrile compositions, polyvinyl phenol, polyvinyl alcohol, and novolac resins.

An inorganic oxide coated film and an organic oxide coated film can be used in combination via lamination. Further, the film thicknesses of these insulation films are commonly 50 nm-3 μm, preferably 100 nm-1 μm.

(Substrate)

As a support material constituting a substrate, various kinds of materials are employable. Usable are, for example, ceramic substrates such as glass, quartz, aluminum oxide, sapphire, silicon nitride, or silicon carbide and semiconductor substrates such as silicon, germanium, gallium arsenide, gallium phosphide, or gallium nitride, as well as paper and unwoven cloth. However, in the present invention, the substrate is preferably composed of a resin. For example, a plastic film sheet is usable. Such a plastic film includes films composed of, for example, polyethylene terephthalate (PET), polyethylene naphthalate (PEN), polyether sulfone (PES), polyether imide, polyether ether ketone, polyphenylene sulfide, polyacrylate, polyimide, polycarbonate (PC), cellulose triacetate (TAC), or cellulose acetate propionate (CAP). Use of such a plastic film makes it possible to reduce weight and to enhance portability and impact resistance, compared to cases in which a glass substrate is used.

Further, an element protection layer can be provided on the thin film transistor of the present invention. The above inorganic oxide or inorganic nitride is listed for the protection layer, which is preferably formed by the above atmospheric pressure plasma method.

### EXAMPLES

The present invention will now specifically be described with reference to examples that by no means limit the scope of the present invention.

### Example 1

In FIG. 3, a production process of a thin film transistor is shown as a schematic cross-sectional view.

<<Production of Thin Film Transistor 1>>

As substrate 6, a glass substrate was used and an ITO coated film of a thickness of 300 nm was formed entirely thereon. Thereafter, gate electrode 4 was formed by etching using a photolithographic method.

Subsequently, via an atmospheric pressure plasma method, gate insulation film 5 of a thickness of 200 nm composed of silicon oxide was formed. Herein, as an atmospheric pressure plasma apparatus, an apparatus based on FIG. 6 described in JP-A No. 2003-303520 was employed.

(Gases Used)

Inert gas: 98.25% by volume of helium

Reactive gas: 1.5% by volume of oxygen gas

Reactive gas: 0.25% by volume of tetraethoxysilane vapor (bubbled with helium)

(Discharge Conditions)

High frequency power supply: 13.56 MHz

Discharge power: 10 W/cm²

(Electrode Conditions)

An electrode was produced by the following method. A stainless steel jacket roll base material having a cooling member via chilled water was coated with alumina at a thickness of 1 mm via ceramic spraying and thereon, a solution prepared by diluting tetramethoxysilane with ethyl acetate was coated and dried, followed by surface smoothing via sealing treatment employing ultraviolet irradiation to produce an electrode. The thus-produced electrode is a grounded roll electrode provided with a dielectric material (dielectric constant: 10) having an Rmax of 5 μm. On the other hand, to produce an application electrode, a hollow square-shape stainless pipe was coated with the above dielectric material under the identical conditions.

Thereby, gate electrode 4 and gate insulation layer (film) 5 were formed on a glass substrate as substrate 6 (FIG. 3.1).

Next, a semiconductor layer was formed.

(Formation of a Metal Oxide Precursor Layer (Referred to also as a Semiconductor Precursor Thin Film))

A metal oxide precursor layer (a semiconductor precursor thin film) was formed as follows.

(Preparation of a Metal Oxide Precursor Forming Coating Liquid)

A metal oxide precursor forming coating liquid was prepared in such a manner that indium nitrate, zinc nitrate, and gallium nitrate, which had been prepared at a metal ratio of 1:1:1 (mole ratio), were dissolved in a mixed solvent of a ratio of water/ethanol=9:1 at a total metal ion concentration of 10% by mass and further dissolution and defoaming treatment (ultrasonic treatment of 10 minutes) were carried out.

Herein, a main solvent in the above coating liquid is water and the boiling point thereof is 100° C.

(Formation of Metal Oxide Precursor Layer 1a)

The above metal oxide precursor forming coating liquid was used as an ink. Substrate temperature was controlled at 40° C. (shown in Table 1) using a commercially available sheet heater. Thereafter, using a piezo-type ink-jet printer of an ejection amount of 4 pl, a dot pattern was formed to form metal oxide precursor layer 1a (FIG. 3.2).

(Evaluation of Film Forming Properties (Referred to also as Film Producing Properties))

Thus-obtained metal oxide precursor layer 1a was observed using a microscope (magnification: 500) and evaluated as described below. As a result, the evaluation was ranked as C since a thick film was formed to the extent that no interference colors are generated.

A: A thin film exhibiting uniform interference colors is formed.

B: Interference colors with fringes are noted and thickness variation in one dot is large.

C: A thick film is formed to the extent that no interference colors are generated or no deposition is generated.

Subsequently, metal oxide precursor layer 1a was formed and then the metal oxide precursor layer was dried by adjusting substrate temperature at 160° C. Thereafter, a heat insulation material exhibiting no microwave absorption incorporating alumina as a main component was covered thereon and irradiation was carried out using microwave of 2.45 GHz at an output power of 500 W. Via this irradiation, substrate temperature was elevated up to 300° C. While the output power was controlled, the substrate temperature was kept at 300° C. for 30 minutes and the metal oxide precursor layer (a semiconductor precursor thin film) was oxidized and then converted to semiconductor active layer 1.

Incidentally, for the above microwave irradiation, μ-Reactor (produced by Shikoku Instrumentation Co., Ltd.) was used. Herein, with regard to temperature, the surface temperature of the base material was measured using a thermocouple (FIG. 3.3).

Subsequently, source electrode 2 and drain electrode 3 were formed at a ratio of L/W=20 μm/50 μm on semiconductor active layer 1 via gold deposition to produce bottom gate/top contact-type thin film transistor 1.

Herein, L and W represent channel length and channel width, respectively (FIG. 3.4).

(Evaluation of Transistor Performance)

The saturation mobility, On/Off ratio, and threshold voltage of thin film transistor 1 were determined under conditions of a gate bias of −40 V-+40 V and a voltage between the source electrode and the drain electrode of 40 V.

<<Production of Thin Film Transistors 2-5>>

Thin film transistors 2-5 each were produced in the same manner as in production of thin film transistor 1 except that in film formation of metal oxide precursor layer 1a, substrate temperature was changed as described in Table 1.

<<Production of Thin Film Transistor 6>>

Thin film transistor 6 was produced in the same manner as in production of thin film transistor 3 except that drying and oxidation of a metal oxide precursor layer was carried out in an electric furnace. A substrate was dried at 160° C., then heated up to 300° C. and kept for 30 minutes for oxidation of the metal oxide precursor layer to carry out conversion to semiconductor active layer 1.

<<Production of Thin Film Transistor 7>>

Thin film transistor 7 was produced in the same manner as in production of thin film transistor 3 except that for a metal oxide precursor forming coating liquid, indium nitrate and gallium nitrate were prepared at a metal ratio of 1:1 (mole ratio) and a mixed solvent of a ratio of water/ethanol=9:1 was used.

<<Production of Thin Film Transistors 8-12>>

Thin film transistors 6-12 were produced in the same manner as in production of thin film transistor 3 except that as the solvent for preparation of a metal oxide precursor forming coating liquid, the mixed solvent of a ratio of water/ethanol=9:1 was replaced with acetonitrile and substrate temperature (° C.) was set at 30° C. as described in Table 1.

Production of Thin Film Transistor 13>>

Thin film transistor 13 was produced in the same manner as in production of thin film transistor 10 except that for a metal oxide precursor forming coating liquid, indium chloride, zinc chloride, and gallium chloride were prepared at a metal ratio of 1:1:1 (mole ratio).

Also as to thin film transistors 2-13, film forming properties (film producing properties) and transistor performance were evaluated in the same manner as for thin film transistor 1.

The obtained results are listed in Table 1.

TABLE 1

| | Main | | | | | | | |
|---|---|---|---|---|---|---|---|---|
| | Solvent | | | | | | | |
| | Boiling | Substrate | | Film | | | | |
| Element | Point | Temperature | A/B | Forming | | On/Off | Threshold | |
| No. | B (° C.) | A (° C.) | (%) | Properties | Mobility | Ratio | Voltage V | Remarks |
| 1 | 100 | 40 | 40 | C(*1) | 0.00001 | 1.5 | −45 | Comparative |
| 2 | 100 | 60 | 60 | B | 0.5 | 6.5 | −10 | Inventive |
| 3 | 100 | 100 | 100 | A | 2.0 | 7.5 | 3 | Inventive |
| 4 | 100 | 150 | 150 | A | 1.5 | 7.3 | 7 | Inventive |
| 5 | 100 | 200 | 200 | C(*2) | — | — | — | Comparative |
| 6 | 100 | 100 | 100 | A | 0.3 | 6.5 | 13 | Inventive |
| 7 | 100 | 100 | 100 | A | 3 | 7.8 | 5 | Inventive |
| 8 | 81 | 30 | 37 | C(*1) | 0.003 | 3.0 | −30 | Comparative |
| 9 | 81 | 50 | 62 | B | 0.3 | 5.0 | −5 | Inventive |
| 10 | 81 | 80 | 99 | A | 0.7 | 5.5 | 10 | Inventive |
| 11 | 81 | 120 | 148 | A | 0.5 | 5.0 | 15 | Inventive |
| 12 | 81 | 180 | 222 | C(*2) | — | — | — | Comparative |
| 13 | 81 | 80 | 99 | B | 0.1 | 4.7 | 17 | Inventive |

(*1)Thick film formed to the extent that no interference colors are generated.
(*2)Almost no deposition generated.

Table 1 clearly shows that in the element of the present invention, excellent film forming properties (film producing properties) of a metal oxide precursor layer and excellent transistor performance are expressed.

### Example 2

<<Production of Thin Film Transistors 14-16>>

Thin film transistors 14-16 were produced in the same manner as in production of thin film transistor 3 of Example 1 except that temperature after film formation was adjusted at 100%, 150%, and 200%, respectively, of the boiling point of the main solvent (boiling point of water: 100° C.).

<<Production of Thin Film Transistors 17-19>>

Thin film transistors 17-19 were produced in the same manner as in production of thin film transistor 10 of Example 1 except that temperature after film formation was adjusted at 98% (80° C.), 185% (150° C.), and 247% (200° C.), respectively, of the boiling point of acetonitrile (boiling point: 81° C.).

Film quality of metal oxide precursor layer 1a in the production process of obtained thin film transistors 14-19 each was observed using a microscope in the same manner as in film forming properties evaluation described in Example 1 and evaluated by ranking as described below.

A: A uniform thin film is formed and no defects such as cracks or fissures are generated at all.

B: Microfine fissures are noted very slightly, resulting in the practically viable level.

C: Cracks are noted in various locations, resulting in the practically unviable level.

Further, evaluation of transistor performance was also carried out in the same manner as in Example 1.

The obtained results are listed in Table 2.

TABLE 2

| | Main | | | | | | |
|---|---|---|---|---|---|---|---|
| | Solvent | | | | | | |
| | Boiling | Drying | | | | | |
| | Point | Temperature | C/B | Film | | On/Off | Threshold |
| Element No. | B (° C.) | C (° C.) | (%) | Quality | Mobility | Ratio | Voltage V |
| 14 | 100 | 100 | 100 | B(*1) | 0.5 | 5.0 | 15 |
| 15 | 100 | 150 | 150 | A | 2.0 | 7.5 | 3 |
| 16 | 100 | 200 | 200 | A | 2.3 | 7.5 | 1 |
| 17 | 81 | 80 | 99 | B(*1) | 0.7 | 5.1 | 17 |
| 18 | 81 | 150 | 185 | A | 0.7 | 5.5 | 10 |
| 19 | 81 | 200 | 247 | A | 0.9 | 6.0 | 8 |

(*1)Microfine fissures are noted very slightly, however, resulting in the practically viable level.

Table 2 shows that thin film transistors 15 (150%) and 16 (200%) of the present invention, produced via a process to fix a film at a temperature (° C.) of at least 150% of the boiling point (° C.) of a main solvent after formation of a metal ion-containing solution on a substrate, are completely free from any defects such as cracks or fissures in film quality evaluation and exhibit further excellent transistor performance, compared to thin film transistor 14 (100%) produced via a different process from the above one.

Similarly, it is shown that thin film transistors 18 (185%) and 19 (247%) of the present invention are completely free from any defects such as cracks or fissures in film quality evaluation and exhibit further excellent transistor performance, compared to thin film transistor 17 (98%) of the present invention produced via a different process from the above one.

1. A method of producing a metal oxide precursor layer comprising:
coating a solution on a substrate, within controlling the substrate's temperature a range of 50%-150% of a boiling point of a main solvent of the solution.

2. The method of claim 1, further comprising:
heating the substrate at a temperature of at least 150% of the boiling point of the main solvent after the coating process.

3. The method of claim 1, wherein the solution contains at least one of a positive ion selected from the group consisting In ion Sn ion Zn ion and mixture thereof.

4. The method of claim 1, wherein the solution contains at least one of a positive ion selected from the group consisting of Ga ion, Al ion and mixture thereof.

5. The method of claim 1, wherein the solution satisfies a mol fraction represented by a Formula 1:
Formula 1
Metal A:Metal B:Metal C=1:0.2-1.5:0-5
in the Formula 1, Metal A is In ion or Sn ion, Metal B is Ga ion or Al ion, and Metal C is Zn ion.

6. The method of claim 1, wherein the solution contains at least one of a negative ion selected from the group consisting of a nitrate ion, a sulfate ion, a phosphate ion, a carbonate ion, an acetate ion, an oxalate ion and mixture thereof.

7. The method of claim 1, wherein the solution contains a nitrate ion.

8. The method of claim 1, wherein the main solvent of the solution is selected from water, alcohol, ether, ester, ketone, glycol ether, an aromatic compound and an alkyl halide.

9. The method of claim 1, wherein the main solvent of the solution is water, ethanol, propanol or acetonitrile.

10. The method of claim 1, wherein the main solvent of the solution is water.

11. The method of claim 1, wherein the coating process on the substrate is performed by a process selected from spray coating, spin coating, blade coating, dip coating, cast coating, roll coating, bar coating, dip coating, mist coating, letterpress printing, intaglio printing, planographic printing, screen printing and ink-jet printing.

12. The method of claim 1, wherein coatin substrate is spray coating or ink-jet printing.

13. A method of producing a metal oxide layer comprising: forming a layer by coating a solution on a substrate, within controlling the substrate's temperature a range of 50%-150% of a boiling point of a main solvent of the solution, and
oxidizing the layer after coating.

14. The method of claim 13, wherein the oxidizing process is performed by a process selected from an oxygen plasma, a thermal oxidation method and UV ozone.

15. The method of claim 13,
wherein the oxidizing process is performed by oxygen plasma.

16. The method of claim 13, wherein the oxygen plasma is performed by atmospheric pressure plasma.

17. A layer produced by using the method of claim 13 is a semiconductor active layer.

18. A layer produced by using the method of claim 13 is a conductive layer.

19. An electronic device produced using the production method of the layer of claim 13.

20. A method of a device comprising:
coating a solution on a substrate, within controlling the substrate's temperature a range of 50%-150% of a boiling point of a main solvent of the solution.
